(19) United States
(12) Patent Application Publication
(10) Pub. No.: US 2026/0331375 A1
(43) Pub. Date: Oct. 22, 2026

(54) MULTILAYER CERAMIC ELECTRONIC COMPONENT

(71) Applicant: TAIYO YUDEN CO., LTD., Tokyo (JP)

(72) Inventor: Yuta SAITO, Tokyo (JP)

(21) Appl. No.: 19/576,845

(22) Filed: Mar. 24, 2026

(30) Foreign Application Priority Data
Mar. 31, 2025 (JP) 2025-059363

(51) Int. Cl. H01G 4/30; H01G 4/012; H01G 4/12

(52) U.S. Cl. CPC H01G 4/30; H01G 4/012; H01G 4/1227

(57) ABSTRACT

A multilayer ceramic electronic component includes: an element including a capacitance portion in which a plurality of layers of a dielectric layer mainly including ceramic crystal particles and internal electrode layers are alternately stacked along a first axis; and a pair of external electrodes. The internal electrode layers are alternately stacked with a first internal electrode layer and a second internal electrode layer in the capacitance portion, and are respectively drawn out to an external surface of the element, the pair of external electrodes are formed on the external surface of the element to be electrically connected to the internal electrode layers of the element, the pair of external electrodes being separated from each other, and the element includes an end margin including a first end margin including only the first internal electrode layer and a second end margin including only the second internal electrode layer.

### CROSS-REFERENCE TO RELATED APPLICATIONS

The present application is based on and claims priority to Japanese Patent Application No. 2025-059363 filed on Mar. 31, 2025, the entire contents of which are hereby incorporated by reference.

### BACKGROUND

### 1. Field of the Invention

The present disclosure relates to a multilayer ceramic electronic component.

### 2. Description of the Related Art

A multilayer ceramic electronic component has a structure in which dielectric layers and internal electrode layers are alternately stacked together. Examples of multilayer ceramic electronic components include multilayer ceramic capacitors (MLCCs).

Multilayer ceramic electronic components such as multilayer ceramic capacitors are mounted and used in various electronic devices such as high-frequency communication systems including mobile phones and vehicle-mounted electronic control devices. Therefore, various types of enhancement in performance are required for the multilayer ceramic electronic components, and studies have been conducted (see, for example, Japanese Laid-Open Patent Application No. 2023-158176).

### RELATED ART DOCUMENTS

### Patent Documents

Patent Document 1: Japanese Laid-Open Patent Application No. 2023-158176

### SUMMARY

A multilayer ceramic electronic component of the present disclosure includes: an element including a capacitance portion in which a plurality of layers of a dielectric layer mainly including ceramic crystal particles and internal electrode layers are alternately stacked along a first axis; and a pair of external electrodes; wherein the internal electrode layers are alternately stacked with a first internal electrode layer and a second internal electrode layer in the capacitance portion, and are respectively drawn out to an external surface of the element; the pair of external electrodes are formed on the external surface of the element to be electrically connected to the internal electrode layers of the element, the pair of external electrodes being separated from each other; the element includes an end margin including a first end margin including only the first internal electrode layer and a second end margin including only the second internal electrode layer between the capacitance portion and the pair of external electrodes; the end margin includes at least one secondary phase penetrating through at least one of the internal electrode layers.

### BRIEF DESCRIPTION OF THE DRAWINGS

FIG. 1 is a partial cross-sectional perspective diagram illustrating a multilayer ceramic capacitor according to an aspect of the present disclosure;

FIG. 2 is a cross-sectional diagram illustrating the multilayer ceramic capacitor according to the aspect of the present disclosure;

FIG. 3 is a cross-sectional diagram illustrating the multilayer ceramic capacitor according to the aspect of the present disclosure;

FIG. 4 is a cross-sectional diagram illustrating details of end margins in the multilayer ceramic capacitor according to the aspect of the present disclosure;

FIG. 5 is a flowchart of a method of manufacturing the multilayer ceramic capacitor according to the aspect of the present disclosure;

FIG. 6A is a diagram illustrating the method of manufacturing the multilayer ceramic capacitor according to the aspect of the present disclosure; and

FIG. 6B is another diagram illustrating the method of manufacturing the multilayer ceramic capacitor according to the aspect of the present disclosure.

### DESCRIPTION OF THE PREFERRED EMBODIMENTS

As described above, multilayer ceramic electronic components are mounted in various electronic devices, and various performance enhancements are required. In particular, in recent years, miniaturization and large-capacity multilayer ceramic electronic components are required, and miniaturization and thinning of each member are required. However, in a multilayer ceramic electronic component, for example, when an external electrode is formed, cracks sometimes occur in the inside of the element called end margin on the side where the internal electrodes are pulled out and connected to the external electrode. Furthermore, cracks are particularly likely to occur due to miniaturization and thinning of each member. For this reason, there has been a demand for a multilayer ceramic electronic component with a low occurrence rate of cracks in the end margin when forming an external electrode.

An object of the present disclosure is to provide a multilayer ceramic electronic component with a low occurrence rate of cracks in the end margin of an element when forming an external electrode.

Embodiments of the present disclosure will be described in detail in the following, but the present disclosure is not limited thereto. In the present specification and the drawings, components having substantially the same functional configuration are denoted by the same reference numerals, thereby omitting redundant descriptions. In the drawings, X-axis, Y-axis, and Z-axis orthogonal to each other are shown as appropriate. The X-axis, Y-axis, and Z-axis define a fixed coordinate system fixed to a multilayer ceramic capacitor, which is an example of a multilayer ceramic electronic component. The X-axis, Y-axis, and Z-axis can correspond to the length, width, and height of a multilayer ceramic capacitor, which is an example of a multilayer ceramic electronic component, when the external shape of the multilayer ceramic capacitor is a substantially rectangular parallelepiped. All of the drawings are shown schematically for the purpose of explaining the structure, and do not accurately describe the size, scale, or the like. In particular, since it is difficult to accurately describe the number of internal electrode layers and the number of dielectric layers due to the paper width, the number of internal electrode layers and the number of dielectric layers may be larger or smaller than the number of layers shown in the drawings.

Hereinafter, the multilayer ceramic electronic component of the present embodiment will be described by using a multilayer ceramic capacitor as an example of the multilayer ceramic electronic component.

### [Multilayer Ceramic Electronic Component]

### (1) Structure of the Multilayer Ceramic Electronic Component

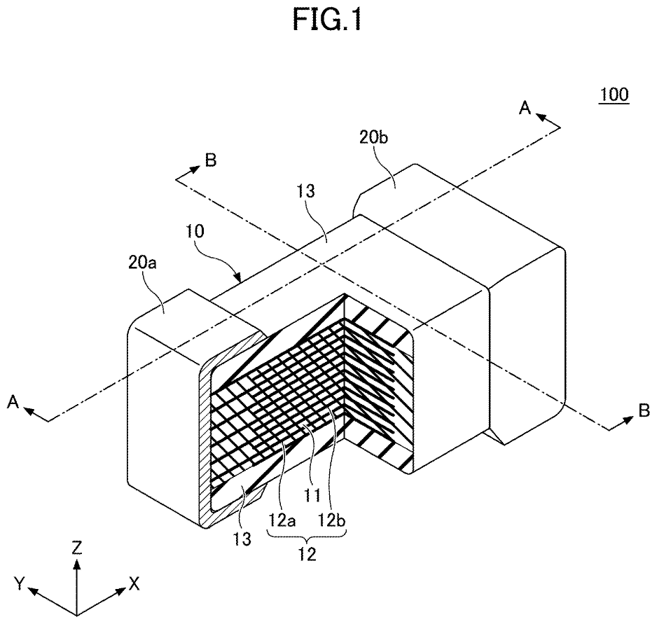

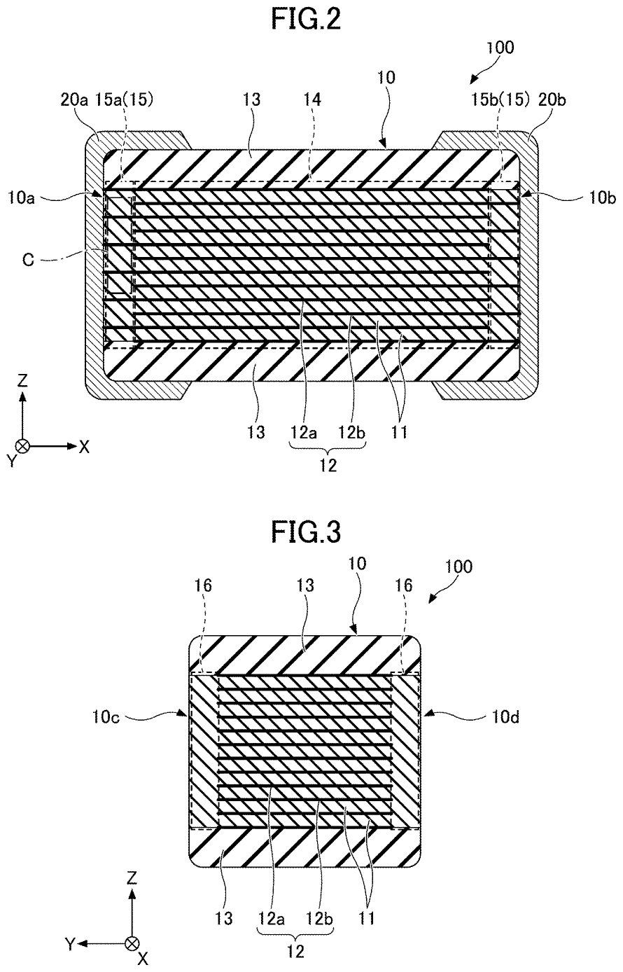

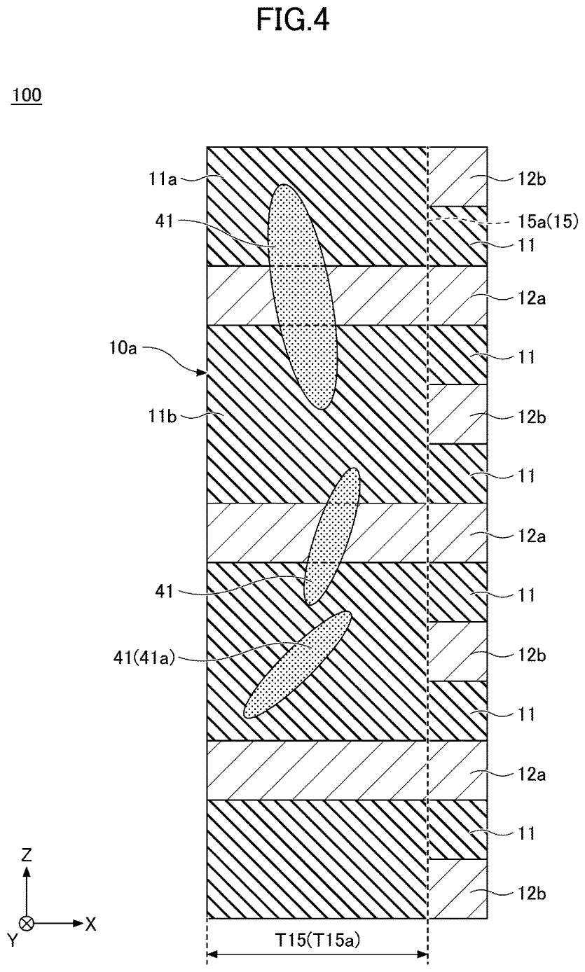

FIG. 1 is a partial cross-sectional perspective diagram illustrating a multilayer ceramic capacitor 100. FIGS. 2 and 3 are cross-sectional diagrams illustrating a multilayer ceramic capacitor. FIG. 2 is a cross-sectional diagram taken along a line A-A in FIG. 1. FIG. 3 is a cross-sectional diagram taken along a line B-B in FIG. 1. As shown in FIGS. 1 to 3, the multilayer ceramic capacitor 100 is provided with an element 10 having a substantially rectangular parallelepiped shape. In the element 10, two facing surfaces are referred to as an upper surface and a lower surface, and four surfaces connecting the upper surface and the lower surface are referred to as side surfaces, respectively. Normally, when a multilayer ceramic capacitor is mounted on a circuit board, a surface on the substrate side is referred to as a lower surface, but this may not be the case. In the examples of FIGS. 1 to 3, the element 10 is provided with a first external electrode 20a and a second external electrode 20b on two facing side surfaces, i.e., a first side surface 10a and a second side surface 10b (see FIG. 2), respectively. The first external electrode 20a extends from the first side surface 10a to four adjacent surfaces. The second external electrode 20b extends from the second side surface 10b to four adjacent surfaces. However, the first external electrode 20a and the second external electrode 20b are separated from each other. The external electrodes may be provided on surfaces of the element 10 without being limited to two facing side surfaces.

A stacking direction in which a dielectric layer 11 and an internal electrode layer 12 are stacked together is a first axis, and in FIGS. 1 to 3, the first axis which is the stacking direction of the dielectric layers 11 and the internal electrode layers 12 is the Z-axis, which is the direction in which the internal electrode layers face each other.

One of the axes perpendicular to the first axis in the stacking direction is a second axis. In FIGS. 1 to 3, the second axis perpendicular to the first axis in the stacking direction is the X-axis. The second axis is along a length direction of the element 10, and is along the direction in which the first side surface 10a and the second side surface 10b of the element 10 face each other or the direction in which the first external electrode 20a and the second external electrode 20b face each other.

The axis perpendicular to the first axis in the stacking direction and perpendicular to the second axis is a third axis. The third axis is along the width of the internal electrode layer 12. In FIGS. 1 to 3, the third axis perpendicular to the first axis in the stacking direction and perpendicular to the second axis is the Y-axis. The third axis is along the direction in which a third side surface 10c and a fourth side surface 10d, which are the two side surfaces other than the first side surface 10a and the second side surface 10b among the four side surfaces of the element 10, face each other (see FIG. 3). The X-axis, the Y-axis, and the Z-axis are orthogonal to each other.

The stacking direction is not limited to the Z direction, but can be any direction. Therefore, for example, the first axis as the stacking direction may be the X-axis of the X direction or the Y-axis of the Y direction.

In the present specification, for the purpose of explaining the general embodiments, a diagram illustrating a specific embodiment thereof may be used. However, the contents described in terms of the coordinate axis system used in the one embodiment are applied to the general coordinate axis system having the stacking direction as the first axis in the general embodiment. For example, in FIGS. 1 to 3, in which the stacking direction coincides with the Z direction as a specific embodiment, the axes described as the X-axis, the Y-axis, and the Z-axis are applied to the general embodiment by being read as the second axis, the third axis, and the first axis, respectively.

The element 10 has a configuration in which the dielectric layer 11 including a ceramic material functioning as a dielectric as a main component and an internal electrode layer 12 are alternately stacked together. Note that the dielectric layer 11 may include ceramic crystal particles as the ceramic material, and may also include a secondary phase. The internal electrode layers 12 include a plurality of first internal electrode layers 12a and a plurality of second internal electrode layers 12b. The first internal electrode layers 12a and the second internal electrode layers 12b are stacked alternately. The end edges of the first internal electrode layers 12a are extended to the surface of the element 10 on which the first external electrode 20a is provided, i.e., the first side surface 10a in the examples shown in FIGS. 1 to 3. The end edges of the second internal electrode layers 12b are extended to the surface of the element 10 on which the second external electrode 20b is provided, i.e., the second side surface 10b in the examples shown in FIGS. 1 to 3. That is, the internal electrode layers 12 are extended from both ends along the X-axis, which is the second axis. Thus, the first internal electrode layers 12a and the second internal electrode layers 12b are alternately conductive to the first external electrode 20a and the second external electrode 20b. Therefore, the multilayer ceramic capacitor 100 has a configuration in which capacitor units are stacked together. In a multilayer body of the dielectric layers 11 and the internal electrode layers 12, the internal electrode layer 12 is disposed on the outermost layer in the stacking direction, and the outer surface in the stacking direction of the multilayer body, i.e., the upper surface and the lower surface in the examples of FIGS. 1 to 3, are each covered with a cover layer 13. The cover layer 13 mainly includes a ceramic material. For example, the cover layer 13 may have the same composition as the dielectric layer 11 or may have a different composition. Note that the configuration shown in FIGS. 1 to 3 is not limited as long as a first internal electrode layer 12a and a second internal electrode layer 12b are exposed in different regions of the surface of the multilayer body and are electrically connected to different external electrodes. The different regions of the surface of the multilayer body may be surface regions of facing surfaces of the multilayer body, surface regions of adjacent surfaces of the multilayer body, or different surface regions of the same surface of the multilayer body. As long as the different external electrodes are separated from each other, the first internal electrode layer 12a and the second internal electrode layer 12b may extend from a surface exposed in the surface region of the multilayer body to another surface.

As illustrated in FIG. 2, a region where the first internal electrode layer 12a connected to the first external electrode 20a and the second internal electrode layer 12b connected to the second external electrode 20b face each other is a region where an electric capacitance is generated in the multilayer ceramic capacitor 100. A region where an electric capacitance is generated is referred to as a capacitance portion 14. That is, the capacitance portion 14 is a region where adjacent internal electrode layers face each other across the dielectric layers 11 connected to different external electrodes.

A region where the first internal electrode layers 12a connected to the first external electrode 20a face each other in the stacking direction without interposing the second internal electrode layer 12b connected to the second external electrode 20b is referred to as a first end margin 15a (see FIG. 2). A region where the second internal electrode layers 12b connected to the second external electrode 20b face each other in the stacking direction without interposing the first internal electrode layer 12a connected to the first external electrode 20a is referred to as a second end margin 15b. In the following description, the first end margin 15a and the second end margin 15b are collectively referred to as an end margin 15.

The end margin 15 is a region of the outer element adjacent to the capacitance portion 14 in the second axis perpendicular to the first axis which is the stacking direction, and is a region of the outer element adjacent to the capacitance portion 14 on the side where the internal electrode layer 12 is drawn out and connected to an external electrode 20 in the direction along the X-axis in the example of FIG. 2. Since the end margin 15 is a region of the outer element adjacent to the capacitance portion 14 where the internal electrode layer is connected to the external electrode, the configuration shown in FIGS. 1 to 3 is not limited depending on the position of the external electrode.

That is, the end margin 15 may be located in a region of the outer element of the capacitance portion 14 adjacent to the capacitance portion 14 such that the first end margin 15a and the second end margin 15b face each other. The end margin 15 may be located in a region of the outer element of the capacitance portion 14 adjacent to the capacitance portion 14 in which the first end margin 15a and the second end margin 15b are disposed adjacent to each other. The end margin 15 may be located in different surface regions of the same surface in which the first end margin 15a and the second end margin 15b are disposed on the same surface of the outer element of the capacitance portion 14 adjacent to the capacitance portion 14.

The different surface regions of the same surface are a form in which a region of the same surface of the element is divided into two regions, which are adjacent to each other as the first end margin 15a and the second end margin 15b.

The end margin 15 includes the first end margin 15a including only the first internal electrode layers 12a and the second end margin 15b including only the second internal electrode layers 12b. Therefore, only one of the first internal electrode layers 12a or the second internal electrode layers 12b is included in a region of one end margin.

It can be said that each end margin 15 is a region where internal electrode layers connected to the same external electrode face each other in the stacking direction without interposing internal electrode layers connected to a different external electrode. The first end margin 15a and the second end margin 15b are regions where internal electrodes of the same potential face each other and do not generate a substantial electric capacitance. The end margin 15 can include a ceramic material as a main component. For example, the end margin 15 may have the same composition as or different from that of the dielectric layer 11. As will be described in the following, the end margin 15 may include a secondary phase having a composition different from that of the dielectric material in addition to the dielectric material.

A side margin 16 is a region provided outside the capacitance portion 14 in the third axis perpendicular to the stacking direction and perpendicular to the second axis, or in the direction along the Y-axis in the example of FIG. 3. That is, the side margin 16 is an outside region adjacent to the capacitance portion 14 as seen from the stacking direction, and is an outside region adjacent to the capacitance portion 14 on the side where the internal electrode layer 12 is not drawn out. The side margin 16 is also a region where no electrical capacitance is generated. The side margin 16 may contain a ceramic material as a main component. For example, the side margin 16 may have the same composition as or different from that of the dielectric layer 11.

The size of the multilayer ceramic capacitor 100 is not particularly limited, but may be, for example, 0.25 mm in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the listed sizes of the multilayer ceramic capacitor 100 are only exemplary, and the multilayer ceramic capacitor is not limited to the above sizes. The size of the multilayer ceramic capacitor 100 may be, for example, length>width≥height, width>length≥height, height>length≥width, and height>width≥length. Here, for example, the length represents a size in an X-axis direction, the width represents a size in a Y-axis direction, and the height represents a size in a Z-axis direction.

As described so far, one form of the multilayer ceramic capacitor 100 of the present embodiment includes the element 10 and the pair of external electrodes. The element 10 includes the capacitance portion 14 in which a plurality of layers of the dielectric layer 11 mainly including ceramic crystal particles and an internal electrode layer 12 are alternately stacked together along the Z-axis, which is the first axis.

The internal electrode layers 12 include the first internal electrode layer 12a and the second internal electrode layer 12b stacked alternately in the capacitance portion 14. The internal electrode layers 12 are drawn out to the external surface of the element 10, and in one embodiment, they can be drawn out to the outside of the element 10 from both ends of the element 10 along the X-axis, which is the second axis orthogonal to the first axis, that is, the first side surface 10a and the second side surface 10b.

The first external electrode 20a and the second external electrode 20b, which are the pair of external electrodes, are formed on the external surface of the element 10 from which the first internal electrode layer 12a and the second internal electrode layer 12b are drawn out to be electrically connected to the internal electrode layers 12 of the element 10, the external electrodes being separated from each other. In one embodiment, the respective external electrodes can be formed to cover the first side surface 10a and the second side surface 10b, which are the surfaces (external surfaces) of both ends of the element 10 along the X-axis, which is the second axis.

The element 10 includes the end margin 15 between the capacitance portion 14 and the first external electrode 20a and the second external electrode 20b. In one embodiment, the capacitance portion 14 includes the end margins 15 at both ends thereof along the X-axis, which is the second axis. The end margin 15 can include only one of the first internal electrode layers 12a or the second internal electrode layers 12b. Specifically, the end margin 15 can include the first end margin 15a and the second end margin 15b. The first end margin 15a includes only the first internal electrode layers 12a as an internal electrode layer. The second end margin 15b includes only the second internal electrode layers 12b as an internal electrode layer.

Hereinafter, each component will be described with reference to the embodiments shown in FIGS. 1 to 3.

In this specification, the first and second numbers are sometimes added to the names of the components, such as the first internal electrode layer and the second internal electrode layer. However, these numbers are added only to specify the components to be described and to avoid confusion, and do not indicate priority or arrangement. Therefore, when there is no possibility of confusion or when they are collectively referred to, they can be simply referred to as internal electrode layers.

### (2) Dielectric Layer

The dielectric layer 11 may include a dielectric material. The dielectric layer 11 may include ceramic crystal particles as a dielectric material as a main component, that is, it may include ceramic crystal particles as the material in largest amount in the ratio of the amounts of materials. In addition to the ceramic crystal particles, the dielectric layer 11 may include a secondary phase of an additive compound described in the following or a reactant thereof. The dielectric layer 11 may include, as a dielectric material, a compound having a perovskite structure represented by the general formula ABO_{3-α} (where, 0≤α≤1) including an element A and an element B. In the general formula, A and B mean elements arranged at the A site and the B site, respectively.

### (2-1) Components Having a Perovskite Structure

When the compound having the perovskite structure has a stoichiometric composition, a representing an amount deviating from the stoichiometric composition is zero and represented by the general formula ABO₃. The compound having the perovskite structure represented by the general formula may have a greater than zero and one or less. That is, the compound having the perovskite structure represented by the general formula may have less oxygen than the stoichiometric composition.

As the compound having the perovskite structure, one or more kinds selected from a group of barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite-type structure and the like may be used.

Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, and the like. The compound having the perovskite structure may contain oxygen deficiency in any of the materials.

The dielectric layer 11 preferably contains barium titanate as a compound having the perovskite structure because it is particularly excellent in dielectric properties, and may contain barium titanate as a main component or may include only barium titanate. Barium titanate has excellent dielectric properties such as extremely high dielectric constant and low dielectric loss. Therefore, when the dielectric layer 11 contains barium titanate as a compound having the perovskite structure, the capacitance of the multilayer ceramic capacitor 100 can be increased. In this specification, “included as a main component” means included as the material in largest amount in terms of the amounts of the substances among the included components.

Furthermore, in the dielectric layer 11, a compound having the perovskite structure may be included as a main component. The dielectric layer 11 may contain, for example, 50 mol % or more or 90 mol % or more of a compound having the perovskite structure.

### (Additive Compounds)

The dielectric layer 11 can also include an additive compound as an optional component.

The additive compound that the dielectric layer 11 can contain is not particularly limited, but can include any one of an oxide, carbonate, or nitride including one more elements selected from a group of zirconium (Zr), magnesium (Mg), molybdenum (Mo), vanadium (V), chromium (Cr), and rare earth elements, or any one of an oxide, carbonate, or nitride including one or more elements selected from a group of cobalt (Co), nickel (Ni), copper (Cu), lithium (Li), boron (B), sodium (Na), potassium (K), calcium (Ca), manganese (Mn), molybdenum (Mo), silicon (Si), and aluminum (Al), or glass including one or more elements selected from a group of cobalt, nickel, copper, lithium, boron, sodium, potassium, calcium, magnesium, manganese, molybdenum, silicon, and aluminum.

The rare earth element is not particularly limited, and one or more kinds selected from a group of scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb) can be used.

### (2-2) Thickness of the Dielectric Layer

The thickness of the dielectric layer 11 is not particularly limited. The thickness of the dielectric layer 11 may be, for example, 1.0 μm or less, 0.8 μm or less, 0.5 μm or less, or 0.4 μm or less from the viewpoint of increasing the number of layers and increasing the capacitance while downsizing the multilayer ceramic capacitor 100.

The lower limit value of the thickness of the dielectric layer 11 is not particularly limited, but two to four times the average diameter of the dielectric material particles (ceramic crystal particles) to be used can be the minimum from the viewpoint of enhancing productivity and yield. For example, when the average diameter of the dielectric material particles to be used is 0.1 μm, the lower limit value of the thickness of the dielectric layer 11 can be 0.2 μm or more and 0.4 μm or less, and the thickness of the dielectric layer 11 can be 0.2 μm or more or 0.4 μm or more, for example.

The average diameter of the dielectric material particles can be an average value obtained by measuring the particle diameter of each dielectric material particle in a cross section including the first axis which is equal to the stacking direction of the multilayer ceramic capacitor 100. For measuring the particle diameter of the dielectric material particles, an optical microscope, a microscope, a scanning electron microscope (SEM) or the like can be used as appropriate. The particle diameter of the dielectric material particles can be a Haywood diameter (the diameter of a circle having an area equal to the area of the dielectric material particles to be evaluated) in an observed cross section. The average diameter, which is an average value of the particle diameters of the dielectric material particles, can be an arithmetic average value of the particle diameters of 50 to 200 arbitrarily selected dielectric material particles. In this specification, the average value means an arithmetic average value unless otherwise specified.

The thickness of the dielectric layer 11 is evaluated in a cross section including the first axis equal to the stacking direction. For example, it is preferable from the viewpoint of ease of polishing and measurement to perform the evaluation on a cross section which further includes the second axis set perpendicular to the stacking direction or a cross section which further includes the third axis set perpendicular to the stacking direction and also perpendicular to the second axis. The multilayer ceramic capacitor 100 is ground along the third axis direction in the former and in the second axis direction in the latter. Five layers are selected from each of the center portion, the upper end portion, and the lower end portion of the exposed dielectric layer 11 in the first axis direction. When the number of layers of the dielectric layer 11 is even, six layers are selected in the center portion. In each of the selected dielectric layers, the thickness is measured at a total of three locations of the center portion, the left end portion, and the right end portion, and the average value of the measured thickness is defined as the thickness of each dielectric layer 11. Furthermore, the average value of the thicknesses of all the selected and evaluated dielectric layers 11 can be defined as the thickness of the dielectric layer 11 in the multilayer ceramic capacitor 100.

In the examples shown in FIGS. 1 and 2, since the first axis, which is the stacking direction, is the Z-axis direction, the multilayer ceramic capacitor 100 is ground along the Y-axis, which is the third axis, to expose an XZ plane in which the dielectric layer 11 and the internal electrode layer 12 are stacked together.

In this case, among the exposed XZ plane, five layers of the dielectric layer 11 positioned in the center along the Z-axis, which is the first axis, and five layers of the dielectric layer 11 positioned at each of the upper end and the lower end along the Z-axis, which is the first axis, are selected. When the number of layers of the dielectric layer 11 is even, six layers may be selected in the center portion. At this time, the dielectric layer 11 to be selected is selected from within the capacitance portion 14.

Then, the thickness of each layer of the selected dielectric layer 11 is measured at three locations separated by ¼, ½, and ¾ of the length of the dielectric layer 11 along the X-axis from the end portion along the X-axis, which is the second axis, and the average value thereof is used as the thickness of the dielectric layer 11. By the same procedure, the thickness of all the selected dielectric layers 11 is measured, and the average value of the thicknesses of all the selected and evaluated dielectric layers 11 can be used as the thickness of the evaluated dielectric layer 11 in the multilayer ceramic capacitor 100.

### (3) Internal Electrode Layer

### (3-1) Components Included in the Internal Electrode Layer

The internal electrode layer 12 can include a base metal element as a main component.

The internal electrode layer 12 can include components used in the internal electrode layer of the multilayer ceramic capacitor. In particular, the internal electrode layer 12 may include a base metal such as nickel (Ni), tin (Sn), and tungsten (W) and alloys including one or more kinds selected from the group of the base metals as the main component, that is, the alloy may include the base metal as the material in the largest amount in the ratio of the amounts of the materials.

The internal electrode layer may contain nickel as a base metal element or may contain nickel as the main component because the internal electrode layer 12 has excellent electrical characteristics and can reduce costs.

The main component of the first internal electrode layer 12a and the main component of the second internal electrode layer 12b may be the same or different. As an example, the main component of both the first internal electrode layer 12a and the second internal electrode layer 12b may be nickel.

### (3-2) Thickness of the Internal Electrode Layer

Although the thickness of the internal electrode layer 12 is not particularly limited, it is preferably 0.8 μm or less, and more preferably 0.6 μm or less, for example, in order to increase the capacitance by increasing the number of layers while downsizing the multilayer ceramic capacitor 100.

The lower limit value of the thickness of the internal electrode layer 12 is not particularly limited, but it may be 0.4 μm or more, for example, when a metal conductive paste is printed by a printing method such as screen printing or gravure printing. For example, when the thin film is formed by a thin film process such as sputtering or evaporation, the thickness can be 0.1 μm or more thinner than that of the printing method. In the evaluation of the thickness of the internal electrode layer 12, the thickness is evaluated on a cross section including the first axis which is equal to the stacking direction as in the evaluation of the thickness of the dielectric layer 11. For example, it is preferable to evaluate the thickness on a cross section which further includes the second axis which is set perpendicular to the stacking direction, or a cross section which further includes the third axis which is set perpendicular to the stacking direction and also perpendicular to the second axis from the viewpoint of ease of polishing and measurement.

Five layers are selected from each of the center portion, the upper end portion, and the lower end portion of the exposed internal electrode layer 12 in the direction of the first axis. When the number of layers of the internal electrode layer 12 is even, six layers are selected in the center portion. In each of the selected internal electrode layers 12, the thickness is measured at three locations in total, i.e., the center portion, the left end portion, and the right end portion, and the average value of the measured thicknesses is defined as the thickness of each internal electrode layer 12. Furthermore, the average value of the thicknesses of all the selected and evaluated internal electrode layers 12 can be defined as the thickness of the internal electrode layer 12 in the multilayer ceramic capacitor 100.

In the examples shown in FIGS. 1 and 2, since the first axis, which is the stacking direction, is the Z-axis direction, the multilayer ceramic capacitor 100 is ground along the Y-axis, which is the third axis, to expose the XZ plane where the dielectric layer 11 and the internal electrode layer 12 are stacked together.

In this case, among the exposed XZ plane, five layers of the internal electrode layers 12 positioned in the center along the Z-axis which is the first axis are selected, and five layers of the internal electrode layers 12 positioned at each of the upper end and the lower end along the Z-axis which is the first axis are selected. When the number of layers of the internal electrode layers 12 is even, six layers may be selected in the center portion. In this case, the internal electrode layers 12 to be selected are selected from within the capacitance portion 14.

Then, the thickness of each layer of the selected internal electrode layers 12 is measured at three locations separated from the end portion by ¼, ½, and ¾ of the length of the internal electrode layers 12 along the X-axis which is the second axis, and the average value of the three locations is used as the thickness of the internal electrode layers 12. In the same procedure, the thickness of all the selected internal electrode layers 12 is measured, and the average value of the thicknesses of all the selected and evaluated internal electrode layers 12 can be used as the thickness of the internal electrode layers 12 in the evaluated multilayer ceramic capacitor 100.

### (4) End Margins

### (4-1) Secondary Phases

As shown in FIG. 4, the end margin 15 can include a secondary phase 41 that penetrates through the internal electrode layers 12. FIG. 4 corresponds to an enlarged diagram of region C in FIG. 2, and is an enlarged diagram of part of the end margin 15. As shown in FIG. 4, even though the internal electrode layer 12 is partially penetrated through by the secondary phase 41, electrical continuity between the internal electrode and the external electrode is secured as a whole because the secondary phase 41 has a non-penetrating portion in the depth on the Y-axis side, which is the third axis.

The inventor of the present disclosure studied a multilayer ceramic electronic component having a low occurrence rate of cracks in the end margin of the element 10 when the external electrode is formed. As a result, the inventor found that the occurrence rate of cracks in the end margin when the external electrode is formed can be reduced by including the secondary phase 41 penetrating through the internal electrode layer 12 in the end margin 15, thereby completing the present disclosure.

In the present specification, the low occurrence rate of cracks in the end margin of the element when the external electrode is formed means that a crack occurrence rate of the end margin, which will be described in the following in the evaluation method of the embodiment, is smaller than that in Comparative Example 1, which is a conventional example. That is, the crack occurrence rate of the end margin is less than 4.50%.

The secondary phase 41 has a composition different from that of the dielectric material included as the main component in the end margin 15. The secondary phase 41 may be, for example, an additive compound added together with the dielectric material as a raw material or a material of the internal electrode layer at the time of firing the end margin 15, or a reaction product of the additive compound and ceramic particles.

The secondary phase 41 may include, for example, copper (Cu). The inclusion of copper in the secondary phase 41 can reduce interdiffusion between components included in the external electrode and components such as base metal elements included in the internal electrode layer 12 at the time of forming the external electrode.

In addition to copper, the secondary phase 41 may contain one or more kinds selected from a group of silicon (Si), lithium (Li), and boron (B). The secondary phase 41 may further contain aluminum (Al).

The inclusion of the secondary phase 41 in the end margin 15 makes it possible to fill voids included in the dielectric layer 11 of the end margin 15 and the internal electrode layer 12 with the secondary phase 41, thereby increasing the mechanical strength of the end margin 15. The term “filling” here includes a case where voids that would otherwise have been generated are filled by the generation of the secondary phase. In addition, the inclusion of the secondary phase 41 penetrating through the internal electrode layer 12 in the end margin 15 makes it possible to increase the adhesion strength between the internal electrode layer 12 and the dielectric layer 11 by, for example, an anchor effect, and it is considered that the mechanical strength of the end margin 15 can be increased from this point of view.

In addition, since copper (Cu) is dissolved in the secondary phase 41, alloying due to mutual diffusion of the main component metal included in the external electrode and the base metal element component included in the internal electrode layer 12 is prevented, and volume expansion due to alloying that causes the generation of cracks does not occur, thereby reducing generation of cracks in the end margin. The end margin 15 has a function of preventing the element 10 from being cracked and short-circuited when the external electrode is formed, while enhancing the moisture resistance of the multilayer ceramic capacitor. Therefore, by enhancing the mechanical strength of the end margin 15, the occurrence of cracks in the end margin 15 of the element 10 can be reduced when the external electrode is formed.

The secondary phase 41 penetrating through the internal electrode layer 12 means that the secondary phase 41 is disposed to contact a first dielectric layer 11a and a second dielectric layer 11b having the internal electrode layer 12 therebetween.

In addition to the secondary phase 41 penetrating through the internal electrode layer 12, the end margin 15 may further include a secondary phase 41a which does not penetrate through the internal electrode layer 12, that is, is disposed between the internal electrode layers 12.

The presence of the secondary phase penetrating through the internal electrode layer 12 can reduce the occurrence of cracks in the end margin 15. For this reason, the content ratio of the secondary phase 41 is not particularly limited. Preferably, for example, the average number of secondary phases penetrating through the internal electrode layers 12 included per 10 internal electrode layers 12 along the Z-axis which is the first axis of the end margin 15 may be one or more, two or more, three or more, or four or more. By setting the average number of secondary phases penetrating through the internal electrode layers 12 included per 10 internal electrode layers 12 along the Z-axis which is the first axis of the end margin 15 to one or more, the occurrence rate of cracks in the end margin when the external electrode is formed can be particularly reduced. Furthermore, as the average number of secondary phases penetrating through the internal electrode layer 12 increases, the occurrence rate of cracks in the end margin when the external electrode is formed can be further reduced.

The upper limit of the average number of secondary phases penetrating through the internal electrode layers 12 included per 10 internal electrode layers 12 along the Z-axis, which is the first axis of the end margin 15, is not particularly limited, but when an excessively large number of secondary phases are arranged, productivity may be lowered. Therefore, the average number of secondary phases penetrating through the internal electrode layers 12 included per 10 internal electrode layers 12 along the Z-axis, which is the first axis of the end margin 15, may be 20 or less, 15 or less, or 10 or less.

### (4-2) Thickness of the End Margin

In recent years, it has been demanded to enhance the electrostatic capacity of a multilayer ceramic electronic component, and it has also been demanded to reduce the thickness of the end margin 15.

However, when the thickness of the end margin 15 is reduced, there has been a problem that the mechanical strength of the multilayer ceramic electronic component is lowered, and the end margin of the element tends to crack when the external electrode is formed.

In contrast to the above, in the multilayer ceramic electronic component of the present embodiment, the mechanical strength of the multilayer ceramic electronic component can be increased because the end margin 15 includes a predetermined secondary phase 41. Since this effect is particularly remarkable when the thickness of the end margin 15 is reduced, it is preferable that the thickness of the end margin 15 is reduced in the multilayer ceramic electronic component of the present embodiment. A thickness T15 of the end margin 15 may be less than 50 μm, 40 μm or less, or 30 μm or less.

The lower limit value of the thickness T15 of the end margin 15 is not particularly limited, but may be, for example, 10 μm or more, or 15 μm or more.

The thickness of the end margin 15 can be evaluated on a cross section including the first axis and the second axis in the stacking direction.

For each of the first internal electrode layers 12a and the second internal electrode layers 12b in the exposed cross section, five layers are selected from each of the center portion, the upper end portion, and the lower end portion in the direction of the first axis. When the number of layers of the first internal electrode layers 12a and the second internal electrode layers 12b is even, six layers are selected in the center portion. In the case of the first end margin 15a, the distance between the end portion of the selected second internal electrode layer 12b and the first side surface 10a is measured as a thickness T15a of the first end margin 15a. In the case of the second end margin 15b, the distance between the end portion of the selected first internal electrode layer 12a and the second side surface 10b is measured as the thickness of the second end margin 15b. Furthermore, the distances between the ends of all the selected and evaluated internal electrode layers 12 and the first side surface 10a or the second side surface 10b, which are the outer surfaces of the end margins 15, are measured. The distance between the ends of the internal electrode layers 12 and the outer surfaces of the end margins 15 means the shortest distance between the ends of the internal electrode layers 12 and the outer surfaces of the end margins 15.

In the case of the first end margin 15a, the average value of the measured distances between the ends of the second internal electrode layers 12b and the first side surface 10a can be used as the thickness of the first end margin 15a in the multilayer ceramic capacitor 100.

In the case of the second end margin 15b, the average value of the measured distances between the ends of the first internal electrode layers 12a and the second side surface 10b can be used as the thickness of the second end margin 15b in the multilayer ceramic capacitor 100.

It is preferable that the measured and calculated thicknesses of the first end margin 15a and the second end margin 15b satisfy the above ranges. The thicknesses of the first end margin 15a and the second end margin 15b may be the same or different.

In the examples shown in FIGS. 1 and 2, since the first axis, which is the stacking direction, is the Z-axis direction, the multilayer ceramic capacitor 100 is ground along the Y-axis, which is the third axis, to expose the XZ plane where the dielectric layer 11 and the internal electrode layer 12 are stacked together.

In this case, among the exposed XZ plane, five layers of the second internal electrode layer 12b positioned at the center along the Z-axis which is the first axis and five layers of the second internal electrode layer 12b positioned at the upper end and the lower end along the Z-axis which is the first axis are selected. When the number of layers of the second internal electrode layer 12b is an even number, six layers may be selected in the center portion.

Then, for each layer of the selected second internal electrode layer 12b, the distance between the end portion of the second internal electrode layer 12b and the first side surface 10a which is the outer surface of the first end margin 15a is measured along the X-axis which is the second axis. The distance between the end portion of each selected second internal electrode layer 12b and the first side surface 10a which is the outer surface of the first end margin 15a is measured by the same procedure, and the average value of the measured distances can be used as the thickness T15a of the first end margin 15a.

The thickness of the second end margin 15b can also be measured and calculated by the same procedure as that of the first end margin 15a except that the second internal electrode layer 12b is replaced with the first internal electrode layer 12a and the first side surface 10a is replaced with the second side surface 10b.

### [Manufacturing Method of Multilayer Ceramic Capacitor]

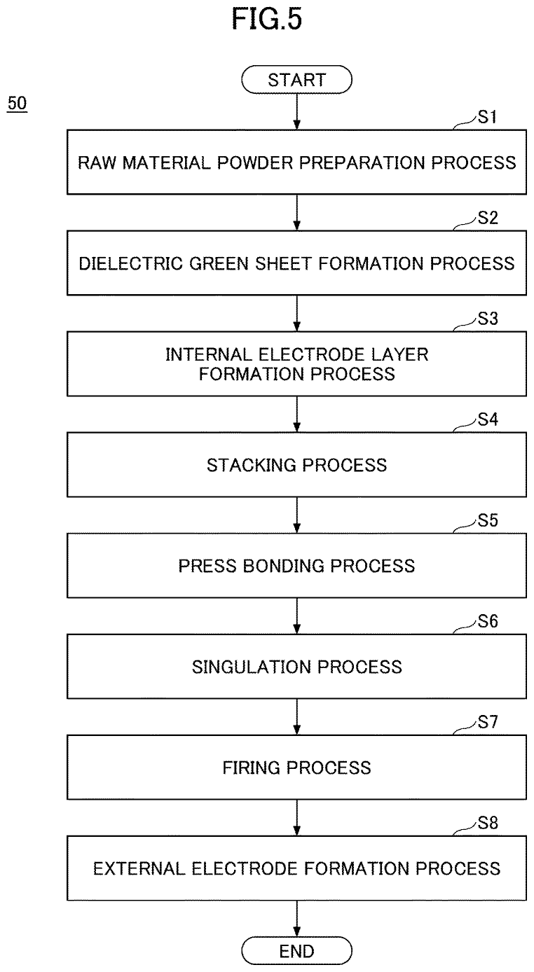

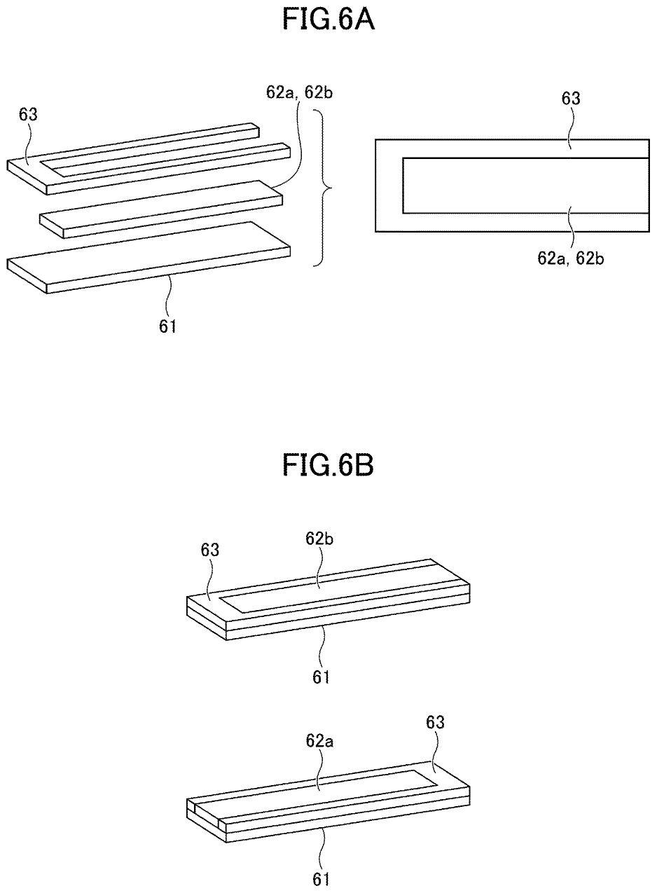

Next, a manufacturing method of the multilayer ceramic capacitor 100 will be described. FIG. 5 is a flowchart 50 illustrating a manufacturing method of the multilayer ceramic capacitor 100. FIGS. 6A and 6B are diagrams illustrating a method of manufacturing the multilayer ceramic capacitor 100.

The method of manufacturing the multilayer ceramic capacitor according to the present embodiment may include a dielectric green sheet formation process, an internal electrode layer formation process, and a firing process. The method of manufacturing the multilayer ceramic capacitor according to the present embodiment including optional processes other than the above processes will be described in the following.

### (1) Raw Material Powder Preparation Process (S1)

In the raw material powder preparation process, raw material powder for forming the dielectric layer 11 can be prepared.

The dielectric layer 11 of the multilayer ceramic capacitor 100 manufactured by the method of manufacturing the multilayer ceramic capacitor according to the present embodiment can include a dielectric material which is a compound having the perovskite structure represented by the general formula ABO_{3-α} (where, 0≤α≤1). The dielectric material, which is a compound having the perovskite structure represented by the general formula ABO_{3-α} (where, 0≤α≤1) has already been described, and the description thereof will be omitted.

The A-site element (element A) and the B-site element (element B) included in the dielectric material included in the dielectric layer 11 are usually included in the dielectric layer 11 in the form of sintered particles of ABO_{3-α} (where, 0≤α≤1). For example, barium titanate is a tetragonal compound having the perovskite structure and exhibits a high relative dielectric constant. Barium titanate can generally be obtained by reacting a titanium raw material such as titanium dioxide with a barium raw material such as barium carbonate. Conventionally, various methods have been known for synthesizing the dielectric material that can be used as the main component of the dielectric layer 11, such as a solid-phase method, a sol-gel method, a hydrothermal method, and the like. In the present embodiment, any of these methods can be employed.

In the raw material powder preparation process, a predetermined additive compound can be added to the dielectric material according to the purpose. The additive compound also serves as a raw material for the secondary phase. Therefore, an additive compound corresponding to the desired composition of the secondary phase can also be added to the dielectric material. Since the secondary phase only needs to be included in the end margin 15, an additive compound corresponding to the desired composition of the secondary phase may be added only to the raw material powder used in the end margin 15. The secondary phase may be included in the dielectric layer other than the end margin, but when the secondary phase is included in the capacitive portion, the amount of the secondary phase in the capacitive portion is preferably small because it causes deterioration of electrical characteristics such as dielectric constant. Therefore, when the amount of the secondary phase is compared between the capacitive portion and the end margin, the amount of the secondary phase in the end margin may be large. When the amount of the secondary phase is compared between the capacitive portion and the end margin, the amount of the secondary phase included in each portion can be compared by the sum of the areas of the secondary phase included in the capacitive portion and the end margin, respectively, in one cross section including the first axis and the second axis. That is, the sum of the areas of the secondary phase included in the end margin may be larger than the square of the area of the secondary phase included in the capacitive portion.

Examples of the additive compound include an oxide, a carbonate, or a nitride including one or more elements selected from a group of zirconium (Zr), magnesium (Mg), molybdenum (Mo), vanadium (V), chromium (Cr), and rare earth elements; an oxide, a carbonate, or a nitride including one or more elements selected from a group of cobalt (Co), nickel (Ni), copper (Cu), lithium (Li), boron (B), sodium (Na), potassium (K), calcium (Ca), manganese (Mn), molybdenum (Mo), silicon (Si), and aluminum (Al); and glass including one or more elements selected from a group of cobalt, nickel, copper, lithium, boron, sodium, potassium, calcium, magnesium, manganese, molybdenum, silicon, and aluminum.

The rare earth element may be one or more selected from a group of scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

The raw material powder can be prepared, for example, by wet-mixing an additive compound with a dielectric material, drying, and grinding. The raw material powder is also referred to as a dielectric pattern material in the following description. For example, the raw material powder thus obtained may be pulverized as necessary to adjust the particle size, or may be combined with a classification treatment to adjust the particle size. By the above processes, the raw material powder as a ceramic material is obtained.

### (2) Dielectric Green Sheet Formation Process (S2)

In the dielectric green sheet formation process, a binder such as polyvinyl butyral (PVB) resin, an organic solvent such as ethanol or toluene, and a plasticizer may be added to the raw material powder obtained in the raw material powder preparation process, and the resultant mixture may be wet mixed to form a slurry. Incidentally, a binder or the like may be added at the time of mixing the raw material powder or the like in the raw material powder preparation process (S1), and the resultant mixture may be wet mixed to form a slurry.

In the dielectric green sheet formation process, the resultant slurry may be used to coat a substrate by, for example, a die coater method or a doctor blade method, and dried to form a dielectric green sheet 61. A polyethylene terephthalate (PET) film may be used as the substrate, for example. A diagram illustrating the dielectric green sheet formation process has been omitted.

Therefore, in the dielectric green sheet formation process (S2), a dielectric green sheet including a compound having the perovskite structure represented by the general formula ABO_{3-α} (where, 0≤α≤1) or an additive compound can be formed. In addition to the perovskite dielectric represented by the general formula, the dielectric green sheet can also include an additive compound as described above.

### (3) Internal Electrode Layer Formation Process (S3)

The first internal electrode layer 12a and the second internal electrode layer 12b may include as a main component one or more kinds selected from base metals such as nickel (Ni), tin (Sn), tungsten (W), and alloys including these.

The main component in the first internal electrode layer 12a and the main component in the second internal electrode layer 12b may be the same or different. As an example, the main component in both the first internal electrode layer 12a and the second internal electrode layer 12b may be nickel.

The metal conductive paste for forming the precursor of the first internal electrode layer 12a and the second internal electrode layer 12b may be prepared by kneading a selected main component, an organic binder, and a solvent.

In the internal electrode layer formation process, as shown in FIG. 6A, a metal conductive paste for forming an internal electrode layer including an organic binder can be printed on the surface of the dielectric green sheet 61 by screen printing, gravure printing, or the like. As the organic binder, for example, ethyl cellulose (EC) or a polyvinyl butyral (PVB) resin can be used. Thus, a first internal electrode layer pattern 62a for the first internal electrode layer 12a or a second internal electrode layer pattern 62b for the second internal electrode layer 12b is arranged on the surface of the dielectric green sheet 61. Various auxiliary agents such as a dispersant or ceramic particles can be added to the metal conductive paste as a co-material. The main component of the ceramic particles is preferably the same as that of the main component ceramic of the dielectric layer 11, although this is not particularly limited. When the ceramic particles are added as a co-material, they can be added at the time of kneading the metal conductive paste. The method of forming the internal electrode layer is not limited to printing, and plating, vacuum deposition, sputtering, or CVD may be used.

In addition, a dielectric pattern paste for the reverse-pattern dielectric layer may be obtained by adding a binder such as ethyl cellulose and an organic solvent such as terpineol to the dielectric pattern material obtained in the raw material powder preparation process, and kneading by a roll mill. Then, as illustrated in FIG. 6A, a dielectric pattern 63 may be arranged on the dielectric green sheet 61 by printing a dielectric pattern paste on a peripheral region where the internal electrode layer pattern is not printed, thereby filling a process with the internal electrode layer pattern. The dielectric pattern 63 may also be referred to as an inverted pattern dielectric layer, and the process of forming the inverted pattern dielectric layer may be referred to as an inverted pattern dielectric layer formation process. A part of the dielectric pattern 63 serves as the end margin 15. Therefore, a component serving as a raw material for the secondary phase included in the end margin 15 of the dielectric pattern 63 may be added. The dielectric pattern 63 may be formed by separating the portion serving as the end margin 15 from the other portion. In this case, the composition of the other portion may be the same as or different from the composition of the portion serving as the end margin 15. By making the composition different, it is easy to obtain an amount of the secondary phase suitable for the end margin 15. The dielectric pattern 63 may include, for example, an additive compound described in the description of the material of the dielectric layer. By including the additive compound in the dielectric pattern 63, it is possible to deposit the secondary phase in the end margin 15 in the firing process described in the following or after the firing process. It is also possible to add particles corresponding to the secondary phase to the dielectric pattern 63.

The dielectric green sheet 61 on which the internal electrode layer pattern and the dielectric pattern 63 are printed is referred to as a laminated unit.

### (4) Stacking Process (S4)

In the stacking process, as illustrated in FIG. 6B, the laminated unit is obtained by stacking the internal electrode layer and the dielectric layer together such that the internal electrode layer and the dielectric layer are alternately arranged, and the internal electrode layer is alternately drawn out to a pair of external electrodes with end edges alternately exposed to both end faces in the length direction of the dielectric layer. Specifically, the dielectric green sheet 61 on which the first internal electrode layer pattern 62a and the dielectric pattern 63 are printed and the dielectric green sheet 61 on which the second internal electrode layer pattern 62b and the dielectric pattern 63 are printed are sequentially stacked together. For example, the number of stacking layers of the laminated units can be 100 to 500 layers.

### (5) Press Bonding Process (S5)

In the press bonding process, a predetermined number of cover sheets, for example, two to 10 layers, are stacked above and below the multilayer body in which the laminated units are stacked and then thermally press bonded.

### (6) Singulation Process (S6)

In the singulation process, a press-bonded body is individualized to obtain a singulated multilayer body. Existing methods such as dicing with a dicer and laser cutting can be used as appropriate.

### (7) Firing Process (S7)

In the firing process, the singulated multilayer body can be degreased and subjected to firing. In the firing process, the degreasing treatment and the firing treatment may be performed sequentially or separately. Conditions for degreasing and firing are not particularly limited. The degreasing may be performed in a nitrogen atmosphere of 250 °C to 500 °C, for example.

The firing may be performed for 5 minutes to 10 hours in a weakly oxidizing atmosphere or a reducing atmosphere having an oxygen partial pressure of 10⁻¹² atm to 10⁻⁸ atm and a temperature range of 1,100 °C to 1,350 °C, for example. The oxygen partial pressure may preferably be 10⁻¹² atm to 10⁻¹⁰ atm.

When the reducing atmosphere is used, one or more kinds selected from hydrogen and carbon monoxide can be used as the reductive gas. An inert gas such as nitrogen or a mixed gas with a rare gas may be used as the reductive gas. The rare gas includes helium and argon.

The temperature range at the time of firing may be preferably 1,150 °C or higher and 1,350 °C or lower. The length of firing time may be preferably 5 minutes or more and less than 15 minutes.

### (8) External Electrode Formation Process (S8)

In an external electrode formation process, a metal conductive paste for forming an external electrode layer including a metal such as a base metal or copper included as a main component such as nickel or the like and an organic binder is formed by screen printing, dipping, or the like, and then subjected to firing to form the external electrode. The method for forming the external electrode is not limited to the printing and dipping, and plating, vacuum deposition, sputtering, or CVD may be used. Furthermore, the external electrode may be formed by printing and applying a conductive resin paste by screen printing, dipping, or the like, and then curing the resin. When necessary, a layer of copper, nickel, or tin may be formed by plating or the like. Thus, the first external electrode 20a and the second external electrode 20b can be formed. The multilayer ceramic capacitor 100 can be manufactured by the above processes.

The above processes are examples, and the manufacturing method of the multilayer ceramic capacitor according to the present embodiment is not limited to the above processes. For example, it is also possible to form an underlying layer of the external electrode by providing the underlying layer of the external electrode on the surface of the singulated multilayer body and firing the underlying layer of the external electrode at the same time as firing the ceramic. In this case, in the external electrode formation process after firing, the external electrode is formed by forming a layer of copper, nickel, or tin by plating on the underlying layer.

### Other Embodiments

Although the embodiments have been described in detail above, the present disclosure is not limited to any particular embodiment, and various modifications and changes are possible within the scope of the appended claims.

For example, although the above embodiment is applied to a multilayer ceramic capacitor having two terminal electrodes, it may be applied to a multilayer ceramic capacitor having three or more terminals.

### EXAMPLES

Specific examples will be described in the following, but the present disclosure is not limited to these examples.

### (1) Evaluation Method

### (1-1) Presence of Secondary Phase Penetrating Through the Internal Electrode Layer

With respect to the multilayer ceramic capacitors produced in the respective examples and comparative examples, a cross section taken along the line A-A in FIG. 1 was exposed, and the end margin 15 of the exposed cross section was observed by the SEM to observe a secondary phase different from that of the dielectric material. When a secondary phase was found, the presence or absence of the secondary phase penetrating through the internal electrode layer was confirmed, and when confirmed, it was determined to be “present”. When no secondary phase was confirmed in the end margin 15 or no secondary phase penetrating through the internal electrode layer was confirmed, it was determined to be “absent”.

### (1-2) Composition of the Secondary Phase

When the secondary phase was evaluated as “present” in the evaluation of “(1-1) Presence of secondary phase penetrating through the internal electrode layer”, the composition of the secondary phase was analyzed by using energy dispersive X-ray spectroscopy (EDX).

As a result of the evaluation, when the secondary phase included in an observation field included a secondary phase in which copper was detected, the column of “Presence of copper solid solution in the secondary phase” was evaluated as “present”. When the secondary phase was not included in the observation field or copper was not detected in the composition of the secondary phase, the column was evaluated as “absent”.

### (1-3) Average Number of Secondary Phases Penetrating Through the Internal Electrode Layer Included in 10 Internal Electrode Layers Along the First Axis

When evaluated as “present” in the evaluation of “(1-1) Presence of secondary phases penetrating through the internal electrode layer”, the number of secondary phases penetrating through the internal electrode layer included in 10 internal electrode layers 12 along the first axis was counted and the average was obtained.

Specifically, six evaluation regions including 10 adjacent internal electrode layers 12 along the first axis were selected within the end margin 15 in the cross section under SEM observation without overlapping. The number of secondary phases penetrating through the internal electrode layer was counted in each evaluation region. Then, an arithmetic mean value of the number of the secondary phases measured in each evaluation region was defined as the average number of secondary phases penetrating through the internal electrode layers included per 10 adjacent internal electrode layers along the first axis of the multilayer ceramic capacitor.

### (1-4) Crack Occurrence Rate of the End Margin and Determination

In each example and comparative example, 400 multilayer ceramic capacitors produced under the same conditions were exposed in one cross section taken along the line A-A in FIG. 1, and the vicinity of the external electrode, i.e., the end margin, of the exposed cross section was observed with an optical microscope, SEM, or the like to evaluate the presence or absence of crack occurrence.

The ratio of the number of multilayer ceramic capacitors in which crack occurrence was confirmed among the 400 multilayer ceramic capacitors was determined to be the crack occurrence rate of the end margin.

When the crack occurrence rate of the end margin was 0% or more and 0.5% or less, it was determined to be ⊚; when it was more than 0.5% and 2% or less, it was determined to be ∘; when it was more than 2% but less than that of the Conventional Example 1, i.e., when it was more than 2% and less than 4.50%, it was determined to be Δ; and when it was not less than that of the conventional example, Comparative Example 1, it was determined to be x.

When the determination is ⊚, the crack occurrence rate can be reduced the most, and the crack occurrence rate becomes higher in the order of ∘, Δ, and x. When it is ⊚, ∘, or Δ, it can be said that the multilayer ceramic capacitor has a lower crack occurrence rate in the end margin than that of the conventional example.

### (2) Sample Preparation Conditions

### Example 1

### (2-1) Raw Material Powder Preparation Process

A multilayer ceramic capacitor was manufactured according to the flowchart 50 shown in FIG. 5.

Specifically, a barium titanate powder, additive compounds such as holmium oxide (Ho₂O₃), magnesium oxide (MgO), manganese carbonate (MnCO₃), and silicon oxide (SiO₂), a polyvinyl butyral (PVB) resin, a solvent, a plasticizer, and a dispersant were wet mixed to obtain a slurry.

### (2-2) Dielectric Green Sheet Formation Process

The obtained slurry was coated on a substrate film, and the slurry coated on the substrate film was dried to obtain a dielectric green sheet.

### (2-3) Internal Electrode Layer Formation Process

Next, ethyl cellulose (EC), a polyvinyl butyral (PVB) resin, etc., as a binder, a solvent, and a plasticizer were added to nickel powder as a main component metal element, and the mixture was wet mixed to obtain a metal conductive paste for forming an internal electrode layer. Then, the metal conductive paste was printed on a partial region of the surface of the dielectric green sheet, and an internal electrode layer pattern including nickel, a base metal element, as a main component was formed on each of the dielectric green sheets.

### (2-4) Inverted Pattern Dielectric Layer Formation Process

Next, a binder such as copper oxide (Cu₂O), silicon oxide (SiO₂), aluminum oxide (Al₂O₃), calcium carbonate (CaCO₃), and ethyl cellulose, and an organic solvent such as terpineol were added to the dielectric pattern material obtained in the raw material powder preparation process, and kneaded with a roll mill. By kneading the above materials, a dielectric pattern paste for an inverted pattern dielectric layer was obtained. Then, as illustrated in FIG. 6A, on the dielectric green sheet 61, the dielectric pattern paste for the inverted pattern dielectric layer was printed on the peripheral region where the internal electrode layer pattern was not printed, such that the dielectric pattern 63 was arranged to form an inverted pattern dielectric layer.

A laminated unit was produced by the above-described dielectric green sheet formation process, the internal electrode layer formation process, and the inverted pattern dielectric layer formation process. The obtained laminated unit includes a dielectric green sheet, an internal electrode layer pattern formed on the surface of the dielectric green sheet, and an inverted pattern dielectric layer.

### (2-5) Stacking Process

Next, 500 laminated units were stacked together to form a multilayer body.

### (2-6) Press Bonding Process and Singulation Process

The multilayer body was press-bonded and then singulated to obtain a chip-like green multilayer body.

### (2-7) Firing Process

Next, the chip-like green multilayer body was degreased in a nitrogen atmosphere at 500 °C.

On the green multilayer body after the degreasing treatment, a metal conductive paste including a metal filler mainly consisting of nickel, a composite material, a binder, a solvent, etc., was coated as an underlayer from both end faces to each side face, and then dried. Then, the green multilayer body coated with the underlayer of the external electrode was put into a firing furnace and subjected to firing.

In the firing process, the green multilayer body was kept for 300 seconds at 1,220 °C, which was the firing temperature, in a reducing atmosphere of a mixed atmosphere of hydrogen and nitrogen with an oxygen partial pressure of 1.0×10⁻¹⁰ atm. At the time of raising the temperature, the amount of the green multilayer body supplied and the oxygen partial pressure were adjusted so as not to cause a rapid change in the firing atmosphere due to the gas generated from the green multilayer body and not to cause cracks in the product obtained after the firing.

### (2-8) External Electrode Formation Process

The first external electrode 20a and the second external electrode 20b were formed on the multilayer body after the firing by plating.

The obtained multilayer ceramic capacitor had a chip shape of 1.0 mm×0.5 mm×0.5 mm, a thickness of the dielectric layer 11 was 0.8 μm, a thickness of the internal electrode layer 12 was 0.6 μm, and the number of laminated layers was 500. The thicknesses of the dielectric layer 11 and the internal electrode layer 12 were evaluated by the above-described procedure.

The obtained multilayer ceramic capacitor was evaluated as described above. The evaluation results are shown in Table 1.

### Example 2 to Example 8

In the inverted pattern dielectric layer formation process, the ratios of copper oxide (Cu₂O), silicon oxide (SiO₂), aluminum oxide (Al₂O₃), and calcium carbonate (CaCO₃) added to the dielectric pattern material obtained in the raw material powder preparation process were the same as those in Example 1, and the total amounts were changed from those in Example 1 such that the average number of secondary phases penetrating through the internal electrode layer was 2, 3, 4, 5, 6, 8, and 10. A binder such as ethyl cellulose and an organic solvent such as terpineol were added thereto, and the resultant mixture was kneaded by a roll mill to obtain a dielectric pattern paste for an inverted pattern layer. Other conditions were the same as those in Example 1.

A multilayer ceramic capacitor was produced and evaluated by the same procedure as in Example 1 except for the above points. The evaluation results are shown in Table 1.

### Example 9 to Example 13

In the inverted pattern dielectric layer formation process, a multilayer ceramic capacitor was produced under the same conditions and procedures as those in Example 1 to Example 8 except that copper oxide (Cu₂O) was not included in the dielectric pattern material obtained in the raw material powder preparation process. That is, the ratios of silicon oxide (SiO₂), aluminum oxide (Al₂O₃), and calcium carbonate (CaCO₃) added to the dielectric pattern material obtained in the raw material powder preparation process were the same as the ratios excluding copper oxide (Cu₂O) in Example 1, and the total amount was changed from that in Example 1 such that the average number of secondary phases penetrating through the internal electrode layer was 1, 2, 3, 4, and 5. A binder such as ethyl cellulose and an organic solvent such as terpineol were added to these, and the mixture was kneaded in a roll mill to obtain a dielectric pattern paste for the inverted pattern layer. Other conditions were the same as those in Example 1.

A multilayer ceramic capacitor was manufactured and evaluated by the same procedure as in Example 1 except for the above points. The evaluation results are shown in Table 1.

### Comparative Example 1

No additive compound was added in the raw material powder preparation process. A multilayer ceramic capacitor was prepared and evaluated by the same procedure as in Example 1 except for the above points. The evaluation results are shown in Table 1.

TABLE 1

| | | | AVERAGE NUMBER OF | | |
|---|---|---|---|---|---|
| | | | SECONDARY PHASES | | |
| | PRESENCE OF | PRESENCE OF | PENETRATING THROUGH | CRACK | |
| | SECONDARY | COPPER SOLID | INTERNAL ELECTRODE | OCCURRENCE | |
| | PHASE PENETRATING | SOLUTION IN | LAYERS INCLUDED | RATE OF | |
| | THROUGH INTERNAL | SECONDARY | IN 10 INTERNAL | END MARGIN | |
| | ELECTRODE LAYER | PHASE | ELECTRODE LAYERS | (%) | DETERMINATION |
| EXAMPLE 1 | PRESENT | PRESENT | 0.9 | 3.50 | Δ |
| EXAMPLE 2 | PRESENT | PRESENT | 2.3 | 1.75 | ◯ |
| EXAMPLE 3 | PRESENT | PRESENT | 3.1 | 1.50 | ◯ |
| EXAMPLE 4 | PRESENT | PRESENT | 3.9 | 0.75 | ◯ |
| EXAMPLE 5 | PRESENT | PRESENT | 5.0 | 0.25 | ⊚ |
| EXAMPLE 6 | PRESENT | PRESENT | 6.2 | 0.00 | ⊚ |
| EXAMPLE 7 | PRESENT | PRESENT | 3.4 | 0.00 | ⊚ |
| EXAMPLE 8 | PRESENT | PRESENT | 10.0 | 0.00 | ⊚ |
| EXAMPLE 9 | PRESENT | ABSENT | 1.0 | 3.75 | Δ |
| EXAMPLE 10 | PRESENT | ABSENT | 2.2 | 2.00 | ◯ |
| EXAMPLE 11 | PRESENT | ABSENT | 3.2 | 1.75 | ◯ |
| EXAMPLE 12 | PRESENT | ABSENT | 4.2 | 1.00 | ◯ |
| EXAMPLE 13 | PRESENT | ABSENT | 5.1 | 0.50 | ⊚ |
| COMPARATIVE | ABSENT | ABSENT | NONE | 4.50 | X |
| EXAMPLE 1 | | | | | |

According to Table 1, in Example 1 to Example 13 in which the secondary phase penetrating through the internal electrode layer could be confirmed in the end margin, the crack occurrence rate in the end margin was enhanced as compared with Comparative Example 1 in which the secondary phase penetrating through the internal electrode layer could not be confirmed. In particular, in Example 2 to Example 8 and Example 10 to Example 13 in which the average number of secondary phases penetrating through the internal electrode layer was two or more, the crack occurrence rate in the end margin was 2% or less, and it was confirmed that a multilayer ceramic capacitor with a low crack occurrence rate in the end margin at the time of forming the external electrode was obtained. In Example 5 to Example 8 and Example 13 in which the average number of secondary phases penetrating through the internal electrode layer was five or more, the crack occurrence rate in the end margin was 0.5% or less, and it was confirmed that the multilayer ceramic capacitor with a low crack occurrence rate in the end margin was more desirable.

By comparing examples in which the average number of secondary phases penetrating through the internal electrode layer is the same, it can be confirmed that the incidence of cracks in the end margin of the example in which copper is solid-dissolved in the secondary phase is lower than that of the example in which copper is not solid-dissolved in the secondary phase. Therefore, it was confirmed that copper solid-dissolved in the secondary phase is effective. The above comparison of examples means a comparison of Example 2 and Example 10 in which the average number of secondary phases penetrating through the internal electrode layer is about two, Example 3 and Example 11 in which the average number of secondary phases penetrating through the internal electrode layer is about three, Example 4 and Example 12 in which the average number of secondary phases penetrating through the internal electrode layer is about four and Example 5 and Example 13 in which the average number of secondary phases penetrating through the internal electrode layer is about five.

Aspects of the present disclosure are, for example, as follows.

<1>A multilayer ceramic electronic component including:
an element including
   a capacitance portion in which a plurality of layers of a dielectric layer mainly including ceramic crystal particles and internal electrode layers are alternately stacked along a first axis; and
   a pair of external electrodes, wherein
the internal electrode layers are alternately stacked with a first internal electrode layer and a second internal electrode layer in the capacitance portion, and are respectively drawn out to an external surface of the element,
the pair of external electrodes are formed on the external surface of the element to be electrically connected to the internal electrode layers of the element, the pair of external electrodes being separated from each other,
the element includes an end margin including a first end margin including only the first internal electrode layer and a second end margin including only the second internal electrode layer between the capacitance portion and the external electrodes, and
the end margin includes a secondary phase penetrating through an internal electrode layer, the internal electrode layer being from among the internal electrode layers.

<2> The multilayer ceramic electronic component according to <1>, wherein
the secondary phase includes copper.

<3> The multilayer ceramic electronic component according to <1> or <2>, wherein
in the end margin, an average number of secondary phases, each of the secondary phases being the secondary phase, penetrating through internal electrode layers included per 10 layers of the internal electrode layers along the first axis is two or more.

<4> The multilayer ceramic electronic component according to any one of <1> to <2>, wherein
the dielectric layer includes a compound having a perovskite structure represented by a general formula ABO_{3-α} (where, 0≤α≤1) including an element A and an element B, and
the internal electrode layer includes a base metal element as a main component.

According to the present disclosure, it is possible to provide a multilayer ceramic electronic component with a low occurrence rate of cracks in the end margin of the element when the external electrode is formed.

What is claimed is:

1. A multilayer ceramic electronic component comprising:
an element including
a capacitance portion in which a plurality of layers of a dielectric layer mainly including ceramic crystal particles and internal electrode layers are alternately stacked along a first axis; and
a pair of external electrodes, wherein
the internal electrode layers are alternately stacked with a first internal electrode layer and a second internal electrode layer in the capacitance portion, and are respectively drawn out to an external surface of the element,
the pair of external electrodes are formed on the external surface of the element to be electrically connected to the internal electrode layers of the element, the pair of external electrodes being separated from each other,
the element includes an end margin including a first end margin including only the first internal electrode layer and a second end margin including only the second internal electrode layer between the capacitance portion and the pair of external electrodes, and
the end margin includes at least one secondary phase penetrating through at least one of the internal electrode layers.

2. The multilayer ceramic electronic component according to claim 1, wherein
the secondary phase includes copper.

3. The multilayer ceramic electronic component according to claim 1, wherein
in the end margin, an average number of secondary phases that penetrate through the internal electrode layer included per 10 layers of the internal electrode layers along the first axis is two or more, each of the secondary phases being the secondary phase.

4. The multilayer ceramic electronic component according to claim 1, wherein
the dielectric layer includes a compound having a perovskite structure represented by a general formula ABO_{3-α} where, 0≤α≤1 including an element A and an element B, and
the internal electrode layer includes a base metal element.
